(19) United States
(12) Patent Application Publication
(10) Pub. No.: US 2025/0081131 A1
(43) Pub. Date: Mar. 6, 2025

(54) Wireless communication system and method having timing synchronization mechanism

(71) Applicant: REALTEK SEMICONDUCTOR CORPORATION, Hsinchu (TW)

(72) Inventors: Wen-Yung Lee, Hsinchu (TW); Hsin-Hong Chou, Hsinchu (TW)

(21) Appl. No.: 18/822,498

(22) Filed: Sep. 3, 2024

(30) Foreign Application Priority Data
Sep. 4, 2023 (TW) 112133552

(51) Int. Cl. H04W 56/00; H04W 74/0816; H04W 84/12

(52) U.S. Cl. CPC H04W 56/0015; H04W 74/0816; H04W 84/12

(57) ABSTRACT

The present disclosure discloses a wireless communication system. A responding station apparatus and an initializing station apparatus perform transmission behavior corresponding to a communication packet. The initializing station apparatus, according to the transmission behavior, calculates an initializing station initial data processing time that an initializing station physical layer processes a data field of the communication packet. The responding station apparatus, according to the transmission behavior, calculates a responding station initial data processing time that a responding station physical layer processes the data field of the communication packet. The responses station apparatus transmits the responding station initial data processing time to the initializing station apparatus such that the initializing station apparatus calibrates an initializing station built-in timing to be synchronous with a responses station built-in timing according to a time difference between the initializing station initial data processing time and the responding station initial data processing time.

### BACKGROUND OF THE INVENTION

### 1. Field of the Invention

The present disclosure relates to a wireless communication system and a wireless communication method having timing synchronization mechanism.

### 2. Description of Related Art

WiFi is a mainstream communication protocol in the contemporary wireless network technology. Indoor positioning is an application of the WiFi technology, which can be performed based on fine timing measurement (FTM) protocol in 802.11 to obtain a positioning result of high precision. In the protocol, the apparatus to be positioned is needed to switch to a corresponding channel at a predetermined timing to perform ranging communication. However, different apparatuses may operate according to different sources of clocks such that the timings thereof are not synchronous. A synchronization mechanism is required for the apparatuses to keep these apparatuses synchronous so as to perform ranging communication at the correct time spot to accomplish the positioning mechanism.

### SUMMARY OF THE INVENTION

In consideration of the problem of the prior art, an object of the present disclosure is to provide a wireless communication system and a wireless communication method having timing synchronization mechanism.

The present invention discloses a wireless communication system having timing synchronization mechanism that includes an initializing station apparatus and a responding station apparatus. The initializing station apparatus operates according to an initializing station built-in timing. The responding station apparatus operates according to a responding station built-in timing and configured to conduct a transmission behavior corresponding to a communication packet with the initializing station apparatus. According to the transmission behavior, the initializing station apparatus calculates an initializing station initial data processing time that an initializing station physical layer of the initializing station apparatus spends to process a data field of the communication packet, and the responding station apparatus calculates a responding station initial data processing time that a responding station physical layer of the responding station apparatus spends to process the data field of the communication packet. The responses station apparatus transmits information of the responding station initial data processing time to the initializing station apparatus such that the initializing station apparatus calibrates the initializing station built-in timing to be synchronous with the responses station built-in timing according to a time difference between the initializing station initial data processing time and the responding station initial data processing time.

The present invention also discloses a wireless communication method having timing synchronization mechanism used in a wireless communication system. The wireless communication method includes steps outlined below. A transmission behavior corresponding to a communication packet is conducted with an initializing station apparatus operating according to an initializing station built-in timing by a responding station apparatus operating according to a responding station built-in timing. According to the transmission behavior, an initializing station initial data processing time that an initializing station physical layer of the initializing station apparatus spends to process a data field of the communication packet is calculated by the initializing station apparatus. A responding station initial data processing time that a responding station physical layer of the responding station apparatus spends to process the data field of the communication packet is calculated by the responding station apparatus. Information of the responding station initial data processing time is transmitted by the responses station apparatus to the initializing station apparatus. The initializing station built-in timing is calibrated by the initializing station apparatus to be synchronous with the responses station built-in timing according to a time difference between the initializing station initial data processing time and the responding station initial data processing time.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of a wireless communication system having timing synchronization mechanism according to an embodiment of the present invention.

FIG. 2A illustrates a diagram of the conduction of the transmission behavior of the initializing station apparatus according to an embodiment of the present invention.

FIG. 2B illustrates a diagram of the conduction of the transmission behavior of the responding station apparatus according to an embodiment of the present invention.

FIG. 3A illustrates a timing diagram of the ranging communication performed by the initializing station apparatus based on IEEE 802.11mc protocol according to an embodiment of the present invention.

FIG. 3B illustrates a timing diagram of the ranging communication performed by the responding station apparatus based on IEEE 802.11mc protocol according to an embodiment of the present invention.

FIG. 4 illustrates a timing diagram of the ranging communication performed by the initializing station apparatus and the responding station apparatus based on IEEE 802.11az protocol according to an embodiment of the present invention.

FIG. 5 illustrates a flow chart of a wireless communication method having timing synchronization mechanism according to an embodiment of the present invention.

### DETAILED DESCRIPTION OF THE PREFERRED EMBODIMENTS

An aspect of the present invention is to provide a wireless communication system and a wireless communication method having timing synchronization mechanism to calculate an initial data processing time that a physical layer spends to process a data field of a communication packet by each of an initializing station apparatus and a responding station apparatus when the transmission behavior corresponding to the communication packet is conducted, such that the initializing station apparatus calibrates an initializing station built-in timing to be synchronous with a responding station built-in timing according to a time difference between the two initial data processing times described above.

Reference is now made to FIG. 1. FIG. 1 illustrates a block diagram of a wireless communication system 100 having timing synchronization mechanism according to an embodiment of the present invention. In an embodiment, each of the apparatuses in the wireless communication system 100 performs communication based on WiFi communication protocol. The wireless communication system 100 includes an initializing station apparatus 110 and a responding station apparatus 120.

The initializing station apparatus 110 is a non-access-point apparatus, such as but not limited to a smartphone or other communication apparatuses. The initializing station apparatus 110 operates according to an initializing station built-in timing of an internal clock signal in the initializing station apparatus 110. The responding station apparatus 120 is an access point apparatus, such as but not limited to a base station. The responding station apparatus 120 operates according to a responding station built-in timing of an internal clock signal of the responding station apparatus 120.

Each of the initializing station apparatus 110 and the responding station apparatus 120 may uses a counter (not illustrated in the figure) operated according to such as, but not limited to a timing synchronization function (TSF) to maintain the timing thereof and operate accordingly. The precision of the counter operated according to the timing synchronization function is in an order of such as, but not limited to microsecond (μs).

Since the initializing station apparatus 110 and the responding station apparatus 120 include different oscillators to generate the clock signals, the initializing station built-in timing and the responding station built-in timing may drift apart after a period of time even if a timing synchronization has already been performed on the initializing station apparatus 110 and the responding station apparatus 120. Another timing synchronization is required to be performed.

In a usage scenario, the responding station apparatus 120 and the initializing station apparatus 110 may perform a ranging communication, in which the ranging communication can be performed based on such as, but not limited to a fine timing measurement (FTM) protocol. Such a ranging communication allows counters (not illustrated in the figure) in the responding station apparatus 120 and the initializing station apparatus 110 to record and exchange the signal transmission time of a signal transmitted therebetween to calculate a distance between the responding station apparatus 120 and the initializing station apparatus 110. The precision of the counter operated according to the fine timing measurement protocol is in an order ranging from such as, but not limited to picosecond (ps) to nanosecond (ns).

In an embodiment, the initializing station apparatus 110 is required to switch to a channel corresponding to the responding station apparatus 120 at a predetermined time spot to perform the ranging communication. Though the ranging communication records the signal transmission time based on the fine timing measurement protocol having a higher precision, the initializing station apparatus 110 schedules the predetermined time spot based on the timing synchronization function having a lower precision.

As a result, the issue that the timings between the apparatuses drift apart may not allow the initializing station apparatus 110 to switch to the channel corresponding to the responding station apparatus 120 at the predetermined time spot under the condition that the timings between the apparatuses are not synchronous. The ranging communication is therefore not able to be performed.

The responding station apparatus 120 may conduct a transmission behavior corresponding to a communication packet with the initializing station apparatus 110. The responding station apparatus 120 and the initializing station apparatus 110 may synchronize the timings thereof according to the information of the transmission behavior. The synchronization mechanism based on the transmission behavior between the responding station apparatus 120 and the initializing station apparatus 110 is described in the following paragraphs.

At first, the initializing station apparatus 110 calculates an initializing station initial data processing time that an initializing station physical layer of the initializing station apparatus 110 spends to process a data field of the communication packet. The responding station apparatus 120 calculates a responding station initial data processing time that a responding station physical layer of the responding station apparatus 120 spends to process the data field of the communication packet.

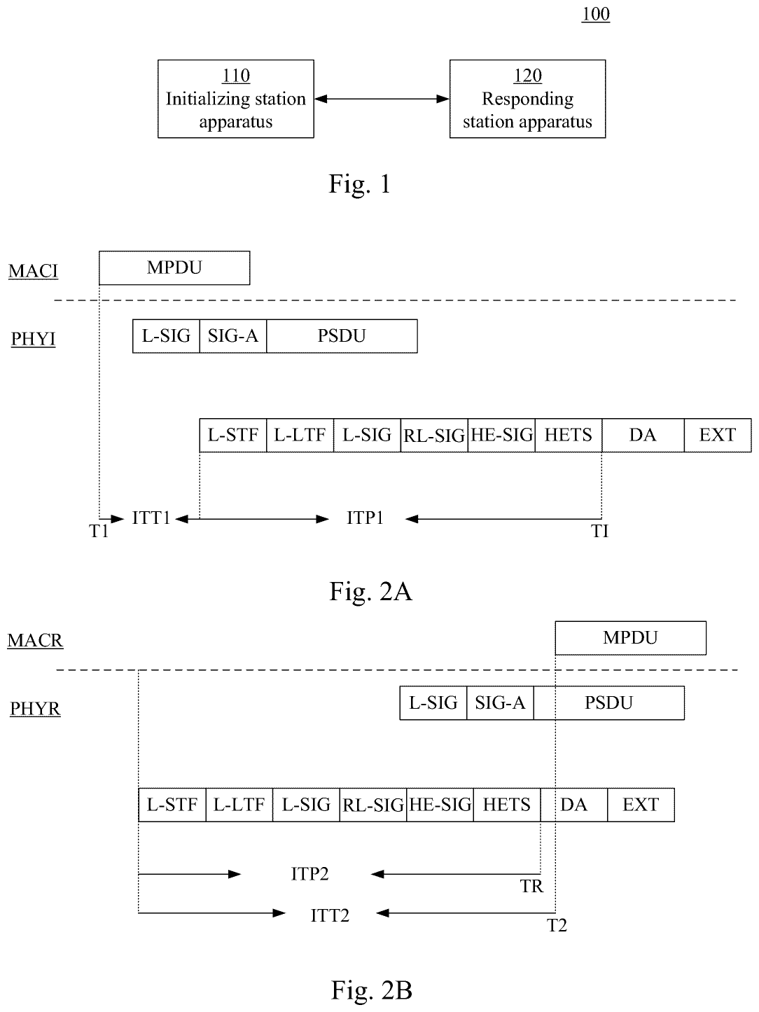

In an embodiment, the transmission behavior described above is conducted by transmitting the communication packet from the initializing station apparatus 110 to the responding station apparatus 120. Reference is made to FIG. 2A and FIG. 2B to describe the transmission behavior conducted between the responding station apparatus 120 and the initializing station apparatus 110 and the calculation of the initializing station initial data processing time and the responding station initial data processing time.

Reference is now made to FIG. 2A. FIG. 2A illustrates a diagram of the conduction of the transmission behavior of the initializing station apparatus 110 according to an embodiment of the present invention. More specifically, FIG. 2A illustrates the behavior of a media access control layer MACI and a physical layer PHYI of the initializing station apparatus 110.

As illustrated in FIG. 2A, the media access control layer MACI transmits a media access control layer protocol data unit MPDU scheduled to be delivered to the physical layer PHYI to become a physical layer service data unit (PLCP service data unit) PSDU. A legacy signal field L-SIG and a signal A field SIG-A can be selectively disposed in front of the physical layer service data unit PSDU.

The physical layer PHYI further performs encoding and scrambling on the legacy signal field L-SIG, the signal A field Sig-A and the physical layer service data unit PSDU to generate a packet protocol data unit PPDU as the communication packet that is actually transmitted.

In an embodiment, the packet protocol data unit PPDU in turn includes a header, a data field DA and an extended section EXT. The header may include such as, but not limited to a short training field L-STF, a long training field L-LTF, a legacy signal field L-SIG, a repeated legacy signal field RL-SIG, a high efficiency signal field HE-SIG and a high efficiency training symbol field HETS. The extended section EXT may include a packet extended field and/or a signal extended field (not illustrated in the figure). It is appreciated that the configuration of the packet described above is merely an example. The present invention is not limited thereto.

In the transmission process of the communication packet described above, the initializing station apparatus 110 records a first time spot T1, by using the initializing station media access control layer MACI, that the initializing station physical layer PHYI is informed by the initializing station media access control layer MACI to perform a packet transmission of the communication packet.

The initializing station media access control layer MACI calculates a first transmission time length ITT1 from a timing that the initializing station physical layer PHYI is informed to perform the packet transmission to a timing that the initializing station physical layer PHYI actually begins to perform the packet transmission.

Subsequently, the initializing station physical layer PHYI processes the communication packet (i.e., the packet protocol data unit PPDU), and the initializing station media access control layer MACI calculates a first processing time length IPT1 that a processing of a content from a packet header initial spot to a data initial spot of the data field DA of the communication packet takes.

The initializing station physical layer PHYI adds the first transmission time length ITT1 and the first processing time length IPT1 to the first time spot T1 to calculate the initializing station initial data processing time TI, in which such a process is expressed by an equation of TI=T1+IPT1+ITT1.

In an embodiment, the timing parameters related to the initializing station physical layer PHYI described above can be reported by the initializing station physical layer PHYI to the initializing station media access control layer MACI, such that the initializing station media access control layer MACI performs the calculation described above.

Reference is now made to FIG. 2B. FIG. 2B illustrates a diagram of the conduction of the transmission behavior of the responding station apparatus 120 according to an embodiment of the present invention. More specifically, FIG. 2B illustrates the behavior of a media access control layer MACR and a physical layer PHYR of the responding station apparatus 120.

As illustrated in FIG. 2B, the physical layer PHYR receives the packet protocol data unit PPDU, in which the configuration thereof is the same as the configuration illustrated in FIG. 2A. The detail is not described herein. The physical layer PHYR performs decoding and descrambling on the packet protocol data unit PPDU to generate the legacy signal field L-SIG, the signal A field SIG-A and the physical layer service data unit PSDU to be transmitted to the media access control layer MACR. The media access control layer MACR removes the legacy signal field L-SIG and the signal A field SIG-A and processes the physical layer service data unit PSDU to generate a media access control layer protocol data unit MPDU.

In the receiving process of the communication packet described above, the responding station apparatus 120 records a second time spot T2, by using the responding station media access control layer MACR, that the responding station media access control layer MACR is informed by the responding station physical layer PHYR to perform a packet receiving of the communication packet.

The responding station physical layer PHYR further processes the communication packet (i.e., the packet protocol data unit PPDU) and the responding station media access control layer MACR calculates a second processing time length IPT2 that the processing of the content from the packet header initial spot to the data initial spot of the data field DA of the communication packet takes.

The responding station media access control layer MACR subsequently calculates a second transmission time length ITT2 from a timing that the responding station physical layer PHYR begins to perform the packet receiving to a timing that the responding station media access control layer MACR is informed by the responding station physical layer PHYR to perform the packet receiving.

The responding station media access control layer MACR subtracts the second transmission time length ITT2 from the second time spot T2 and adds the second processing time length IPT2 thereon subsequently to calculate the responding station initial data processing time TR, in which such a process is expressed by an equation of TR=T2−ITT2+IPT2.

In an embodiment, the timing parameters related to the initializing station physical layer PHYI described above can be reported by the initializing station physical layer PHYI to the initializing station media access control layer MACI, such that the initializing station media access control layer MACI performs the calculation described above.

After finishing the calculation of the initializing station initial data processing time TI and the responding station initial data processing time TR, the responding station apparatus 120 transmits the information of the responding station initial data processing time TR to the initializing station apparatus 110, such that the initializing station apparatus 110 calibrates the initializing station built-in timing to be synchronous with the responses station built-in timing according to a time difference (TR−TI) between the initializing station initial data processing time TI and the responding station initial data processing time TR.

More specifically, the initializing station apparatus 110 adds (TR−TI) to the initializing station built-in timing so as to be synchronous with the responding station built-in timing.

It is appreciated that though the packet transmission of the communication packet between the initializing station apparatus 110 and the responding station apparatus 120 actually requires a certain time to be performed, the transmission performed at the speed of light or at a speed close to the speed of light spends a time that is close to zero in the order of microsecond such that the time difference between the signal transmission of the initializing station apparatus 110 and the signal receiving of the responding station apparatus 120 can be neglected. In other words, the signal transmission of the initializing station apparatus 110 and the signal receiving of the responding station apparatus 120 can be viewed as being performed simultaneously such that the timing synchronization can be performed according to the method described above. The synchronization mechanism between the initializing station apparatus 110 and the responding station apparatus 120 can thus be accomplished.

In an embodiment, the responding station apparatus 120 and the initializing station apparatus 110 perform communication, e.g., the packet transmission and the packet receiving, according to IEEE 802.11mc protocol such that the transmission behavior is conducted by transmitting the communication packet from the initializing station apparatus 110 to the responding station apparatus 120. Further, the synchronization mechanism described above can be accomplished according to the ranging communication performed between the initializing station apparatus 110 and the responding station apparatus 120.

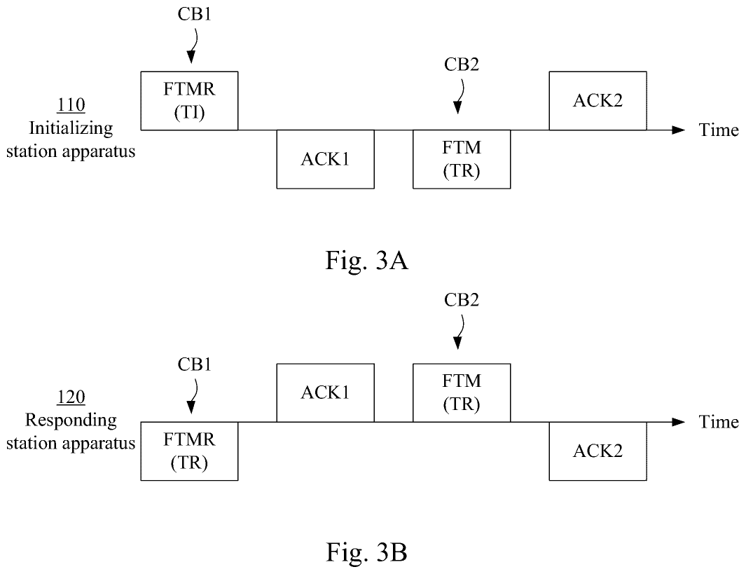

Reference is now made to FIG. 3A and FIG. 3B. FIG. 3A illustrates a timing diagram of the ranging communication performed by the initializing station apparatus 110 based on IEEE 802.11mc protocol according to an embodiment of the present invention. FIG. 3B illustrates a timing diagram of the ranging communication performed by the responding station apparatus 120 based on IEEE 802.11mc protocol according to an embodiment of the present invention.

Both of FIG. 3A and FIG. 3B include an X-axis representing the progress of time. In FIG. 3A, the signals transmitted by the initializing station apparatus 110 are illustrated above the X-axis and the signals received by the initializing station apparatus 110 are illustrated below the X-axis. In FIG. 3B, the signals transmitted by the responding station apparatus 120 are illustrated above the X-axis and the signals received by the responding station apparatus 120 are illustrated below the X-axis.

The ranging communication performed based on IEEE 802.11mc protocol includes a first communication behavior CB1 and a second communication behavior CB2 illustrated in FIG. 3A and FIG. 3B. The description is made first on the ranging communication between the initializing station apparatus 110 and the responding station apparatus 120 and the description is subsequently made on how the synchronization mechanism is accomplished in the ranging communication.

Corresponding to the first communication behavior CB1, the initializing station apparatus 110 begins to transmit a ranging request signal FTMR as illustrated in FIG. 3A and the responding station apparatus 120 begins to receive the ranging request signal FTMR as illustrated in FIG. 3B.

In response to the receiving of the ranging request signal FTMR in the first communication behavior CB1 described above, the responding station apparatus 120 transmits a first acknowledgement signal ACK1 as illustrated in FIG. 3B. The initializing station apparatus 110 receives the first acknowledgement signal ACK1 as illustrated in FIG. 3A.

Subsequently, corresponding to the second communication behavior CB2, the responding station apparatus 120 transmits a ranging signal FTM as illustrated in FIG. 3B and the initializing station apparatus 110 receives the ranging signal FTM as illustrated in FIG. 3A.

In response to the receiving of the ranging signal FTM in the second communication behavior CB2 described above, the initializing station apparatus 110 transmits a second acknowledgement signal ACK2 as illustrated in FIG. 3A. The responding station apparatus 120 receives the second acknowledgement signal ACK2 as illustrated in FIG. 3B.

The responding station apparatus 120 records a first time of departure of the transmission of the ranging signal FTM. The initializing station apparatus 110 records a first time of arrival of the receiving of the ranging signal FTM. The initializing station apparatus 110 further records a second time of departure of the second acknowledgement signal ACK2 and the responding station apparatus 120 records a second time of arrival of the second acknowledgement signal ACK2.

The responding station apparatus 120 further transmits the recorded first time of departure and the recorded second time of arrival to the initializing station apparatus 110. The initializing station apparatus 110 calculates the distance between the initializing station apparatus 110 and the responding station apparatus 120 according to the first time of departure, the first time of arrival, the second time of departure and the second time of arrival to accomplish the ranging process. In different embodiments, the initializing station apparatus 110 may use different calculation methods suitable for calculating the distance. The detail is not described herein.

It is appreciated that the first time of departure, the first time of arrival, the second time of departure and the second time of arrival can be recorded by the responding station apparatus 120 and the initializing station apparatus 110 according to the counters thereof operated based on the fine timing measurement protocol.

As a result, in the ranging communication described above, the initializing station apparatus 110 and the responding station apparatus 120 are configured to perform the packet transmission and the packet receiving of the communication packet of the ranging request signal FTMR in the first communication behavior CB1 of the ranging communication. The initializing station initial data processing time TI and the responding station initial data processing time TR can thus be respectively calculated. The recording and calculation of the related time spots and the time lengths can be performed according to the counters corresponding to the timing synchronization function (TSF) under the fine timing measurement protocol.

Moreover, the initializing station apparatus 110 and the responding station apparatus 120 are configured to transmit the responding station initial data processing time TR from the responding station apparatus 120 to the initializing station apparatus 110 in the second communication behavior CB2 of the ranging communication.

In an embodiment, the packet configuration of the ranging signal FTM transmitted in the second communication behavior CB2 by the responding station apparatus 120 can be understood according to the specification of the fine timing measurement protocol of IEEE 802.11mc and may include a synchronization information entry. The synchronization information entry is such as, but not limited to a timing synchronization function (TSF) sync information entry. The responding station apparatus 120 fills the responding station initial data processing time TR to the timing synchronization function synchronization information entry such that the initializing station apparatus 110 analyzes the entry and retrieves the responding station initial data processing time TR therefrom when the packet of the ranging signal FTM is received.

As a result, based on the ranging communication performed based on IEEE 802.11mc protocol, the initializing station apparatus 110 calibrates the initializing station built-in timing according to the time difference (TR−TI) between the initializing station initial data processing time TI and the responding station initial data processing time TR to be synchronous with the responding station built-in timing.

The above embodiment is described under the condition that the transmission behavior is performed by transmitting the communication packet from the initializing station apparatus 110 to the responding station apparatus 120.

However, in another embodiment, the transmission behavior is performed by transmitting the communication packet from the responding station apparatus 120 to the initializing station apparatus 110.

Under such a condition, the responding station apparatus 120 performs calculation corresponding to the transmission behavior illustrated in FIG. 2A. More specifically, the responding station apparatus 120 records the first time spot T1, calculates the first transmission time length ITT1, calculates the first processing time length IPT1, and further adds the first transmission time length ITT1 and the first processing time length IPT1 to the first time spot T1 to calculate the responding station initial data processing time TR, in which the result is expressed by the equation of TR=T1+IPT1+ITT1.

On the other hand, the initializing station apparatus 110 performs calculation corresponding to the transmission behavior illustrated in FIG. 2B. More specifically, the initializing station apparatus 110 records the second time spot T2, calculates the second transmission time length ITT2, calculates the second processing time length IPT2, and further subtracts the second transmission time length ITT2 from the second time spot T2 and adds the second processing time length IPT2 thereon subsequently to calculate the initializing station initial data processing time TI, in which the result is expressed by the equation of TI=T2−ITT2+IPT2.

The detail of the processing of the time information described above, e.g., the operation of the layers of the protocol, can be referred to the previous embodiment and is not described herein.

After finishing the calculation of the initializing station initial data processing time TI and the responding station initial data processing time TR, the responding station apparatus 120 transmits the information of the responding station initial data processing time TR to the initializing station apparatus 110 such that the initializing station apparatus 110 calibrates the initializing station built-in timing to be synchronous with the responding station built-in timing according to the time difference (TR−TI) between the initializing station initial data processing time TI and the responding station initial data processing time TR. More specifically, the initializing station apparatus 110 adds (TR−TI) to the initializing station built-in timing to be synchronous with the responding station built-in timing.

In an embodiment, the responding station apparatus 120 and the initializing station apparatus 110 perform communication, e.g., the packet transmission and the packet receiving, according to IEEE 802.11az protocol such that the responding station apparatus 120 conducts the transmission behavior by transmitting the communication packet to the initializing station apparatus 110. Further, the synchronization mechanism described above can be accomplished according to the ranging communication performed between the initializing station apparatus 110 and the responding station apparatus 120.

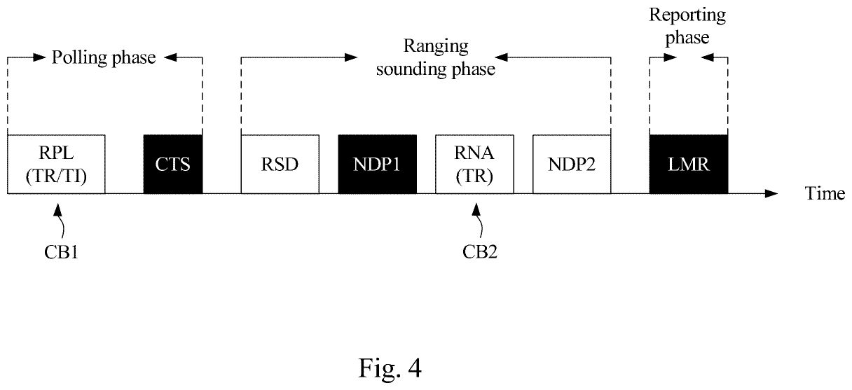

Reference is now made to FIG. 4. FIG. 4 illustrates a timing diagram of the ranging communication performed by the initializing station apparatus 110 and the responding station apparatus 120 based on IEEE 802.11az protocol according to an embodiment of the present invention. FIG. 4 includes an X-axis representing the progress of time. The signals transmitted by the initializing station apparatus 110 are illustrated as black blocks labeled with white letters. The signals transmitted by the responding station apparatus 120 are illustrated as white blocks labeled with black letters.

The ranging communication performed based on IEEE 802.11az protocol includes the first communication behavior CB1 and the second communication behavior CB2 illustrated in FIG. 4. The description is made first on the ranging communication between the initializing station apparatus 110 and the responding station apparatus 120 and the description is subsequently made on how the synchronization mechanism is accomplished in the ranging communication.

Corresponding to the first communication behavior CB1, the responding station apparatus 120 begins to transmit a ranging polling signal RPL and the initializing station apparatus 110 begins to receive the ranging polling signal RPL as illustrated in FIG. 4.

In response to the receiving of the ranging polling signal RPL in the first communication behavior CB1, the initializing station apparatus 110 transmits a clear-to-send signal CTS as illustrated in FIG. 4 to be received by the responding station apparatus 120. The transmission and receiving of the ranging polling signal RPL and the clear-to-send signal CTS described above correspond to a polling phase of the ranging communication.

Subsequently, the responding station apparatus 120 transmits a ranging sounding signal RSD to be received by the initializing station apparatus 110 as illustrated in FIG. 4. In response to the receiving of the ranging sounding signal RSD, the initializing station apparatus 110 transmits a first null data packet signal NDP1 to be received by the responding station apparatus 120.

In response to the second communication behavior CB2, the responding station apparatus 120 further transmits a ranging null data packet announcement signal RNA to be received by the initializing station apparatus 110.

The responding station apparatus 120 further transmits a second null data packet signal signal NDP2 to be received by the initializing station apparatus 110.

The transmission and the receiving of the ranging sounding signal RSD, the first null data packet signal signal NDP1, the ranging null data packet announcement signal RNA and the second null data packet signal signal NDP2 correspond to a ranging sounding phase of the ranging communication.

In the ranging sounding phase, the initializing station apparatus 110 records the first time of departure of the transmission of the first null data packet signal signal NDP1. The responding station apparatus 120 records the first time of arrival of the receiving of the first null data packet signal signal NDP1. The responding station apparatus 120 further records the second time of departure of the transmission of the second null data packet signal signal NDP2. The initializing station apparatus 110 records the second time of arrival of the receiving of the second null data packet signal signal NDP2.

The responding station apparatus 120 further transmits the recorded second time of departure and the recorded first time of arrival to the initializing station apparatus 110 by using a location measurement report signal LMR. The transmission and the receiving of the location measurement report signal LMR described above correspond to a reporting phase of the ranging communication.

The initializing station apparatus 110 calculates the distance between the initializing station apparatus 110 and the responding station apparatus 120 according to the first time of departure, the first time of arrival, the second time of departure and the second time of arrival to accomplish the ranging process. In different embodiments, the initializing station apparatus 110 may use different calculation methods suitable for calculating the distance. The detail is not described herein.

It is appreciated that the first time of departure, the first time of arrival, the second time of departure and the second time of arrival can be recorded by the responding station apparatus 120 and the initializing station apparatus 110 according to the counters thereof operated based on the fine timing measurement protocol.

As a result, in the ranging communication described above, the initializing station apparatus 110 and the responding station apparatus 120 are configured to perform the packet transmission and the packet receiving of the communication packet of the ranging polling signal RPL in the first communication behavior CB1 of the ranging communication. The initializing station initial data processing time TI and the responding station initial data processing time TR can thus be respectively calculated. The recording and calculation of the related time spots and the time lengths can be performed according to the counters corresponding to the timing synchronization function under the fine timing measurement protocol.

Moreover, the initializing station apparatus 110 and the responding station apparatus 120 are configured to transmit the responding station initial data processing time TR from the responding station apparatus 120 to the initializing station apparatus 110 in the second communication behavior CB2 of the ranging communication.

In an embodiment, the packet configuration of the ranging null data packet announcement signal RNA transmitted in the second communication behavior CB2 by the responding station apparatus 120 can be understood according to the specification of the fine timing measurement protocol of IEEE 802.11az and may include a synchronization information entry. The synchronization information entry is such as, but not limited to a partial timing synchronization function (partial TSF) sync information entry. The responding station apparatus 120 fills the responding station initial data processing time TR to the partial timing synchronization function synchronization information entry such that the initializing station apparatus 110 analyzes the entry and retrieves the responding station initial data processing time TR therefrom when the ranging null data packet announcement signal RNA is received.

As a result, based on the ranging communication performed based on IEEE 802.11az protocol, the initializing station apparatus 110 calibrates the initializing station built-in timing according to the time difference (TR−TI) between the initializing station initial data processing time TI and the responding station initial data processing time TR to be synchronous with the responding station built-in timing.

It is appreciated that the performance of the ranging communication described above is merely an example. In other embodiments, the initializing station apparatus and the responding station apparatus may use other methods to perform ranging communication so as to accomplish the timing synchronization mechanism.

Moreover, in the embodiments described above, the first communication behavior corresponds to an initial signal of the ranging communication and the second communication behavior corresponds to an actual ranging signal of the ranging communication. However, under the condition that the required information can be exchanged, the first communication behavior and the second communication behavior for the initializing station apparatus and the responding station apparatus to perform synchronization may correspond to other behaviors. The present invention is not limited thereto.

Further, the initializing station apparatus and the responding station apparatus may use other communications other than the ranging communication to perform information exchanging to accomplish the timing synchronization mechanism.

Besides, in order to simplify the description, only a single initializing station apparatus and a single responding station apparatus are illustrated in FIG. 1. Actually, the wireless communication system may include a plurality of initializing station apparatuses and a plurality of responding station apparatuses. The timing synchronization mechanism described above can be applied thereto.

The wireless communication system of the present invention calculates an initial data processing time that a physical layer spends to process a data field of a communication packet by each of an initializing station apparatus and a responding station apparatus when the transmission behavior corresponding to the communication packet is conducted, such that the initializing station apparatus calibrates an the initializing station built-in timing to be synchronous with a responding station built-in timing according to a time difference between the two initial data processing times described above.

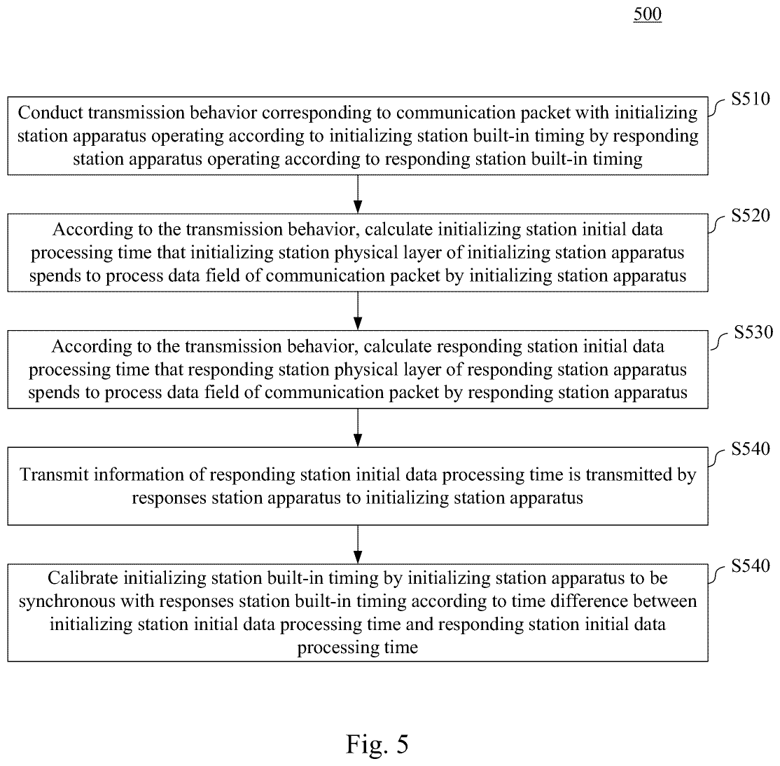

Reference is now made to FIG. 5. FIG. 5 illustrates a flow chart of a wireless communication method 500 having timing synchronization mechanism according to an embodiment of the present invention.

Besides the apparatus described above, the present invention further discloses the wireless communication method 500 that can be used in such as, but not limited to the wireless communication system 100 illustrated in FIG. 1. An embodiment of the wireless communication method 500 is illustrated in FIG. 5 and includes the steps outlined below.

In step S510, the transmission behavior corresponding to the communication packet is conducted with the initializing station apparatus 110 operating according to the initializing station built-in timing by the responding station apparatus 120 operating according to the responding station built-in timing.

In step S520, according to the transmission behavior, the initializing station initial data processing time TI that the initializing station physical layer PHYI of the initializing station apparatus 110 spends to process the data field DA of the communication packet is calculated by the initializing station apparatus 110.

In step S530, according to the transmission behavior, the responding station initial data processing time TR that the responding station physical layer PHYR of the responding station apparatus 120 spends to process the data field DA of the communication packet is calculated by the responding station apparatus 120.

In step S540, the information of the responding station initial data processing time TR is transmitted by the responses station apparatus 120 to the initializing station apparatus 110.

In step S550, the initializing station built-in timing is calibrated by the initializing station apparatus 110 to be synchronous with the responses station built-in timing according to the time difference (TR−TI) between the initializing station initial data processing time TI and the responding station initial data processing time TR.

It is appreciated that the embodiments described above are merely an example. In other embodiments, it is appreciated that many modifications and changes may be made by those of ordinary skill in the art without departing, from the spirit of the invention.

In summary, the wireless communication system and the wireless communication method having timing synchronization mechanism calculate an initial data processing time that a physical layer spends to process a data field of a communication packet by each of an initializing station apparatus and a responding station apparatus when the transmission behavior corresponding to the communication packet is conducted, such that the initializing station apparatus calibrates an initializing station built-in timing to be synchronous with a responding station built-in timing according to a time difference between the two initial data processing times described above.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A wireless communication system having timing synchronization mechanism, comprising:
an initializing station apparatus operating according to an initializing station built-in timing; and
a responding station apparatus operating according to a responding station built-in timing and configured to conduct a transmission behavior corresponding to a communication packet with the initializing station apparatus;
wherein according to the transmission behavior, the initializing station apparatus calculates an initializing station initial data processing time that an initializing station physical layer of the initializing station apparatus spends to process a data field of the communication packet, and the responding station apparatus calculates a responding station initial data processing time that a responding station physical layer of the responding station apparatus spends to process the data field of the communication packet; and
wherein the responses station apparatus transmits information of the responding station initial data processing time to the initializing station apparatus such that the initializing station apparatus calibrates the initializing station built-in timing to be synchronous with the responses station built-in timing according to a time difference between the initializing station initial data processing time and the responding station initial data processing time.

2. The wireless communication system of claim 1, wherein the transmission behavior is conducted by transmitting the communication packet from the initializing station apparatus to the responding station apparatus;
the initializing station apparatus is configured to:
record a first time spot, by using an initializing station media access control (MAC) layer of the initializing station apparatus, that the initializing station physical layer is informed by the initializing station media access control layer to perform a packet transmission of the communication packet;
calculate a first transmission time length, by using the initializing station media access control layer, from a timing that the initializing station physical layer is informed to perform the packet transmission to a timing that the initializing station physical layer actually begins to perform the packet transmission;
process the communication packet by using the initializing station physical layer and calculate a first processing time length, by using the initializing station media access control layer, that a processing of a content from a packet header initial spot to a data initial spot of the data field of the communication packet takes;
add the first transmission time length and the first processing time length to the first time spot by using the initializing station media access control layer to calculate the initializing station initial data processing time; and
the responding station apparatus is configured to:
record a second time spot, by using a responding station media access control layer of the responding station apparatus, that the responding station media access control layer is informed by the responding station physical layer to perform a packet receiving of the communication packet;
process the communication packet by using the responding station physical layer and calculate a second processing time length, by using the responding station media access control layer, that the processing of the content from a packet header initial spot to a data initial spot of the data field of the communication packet takes;
calculate a second transmission time length, by using the responding station media access control layer, from a timing that the responding station physical layer begins to perform the packet receiving to a timing that the responding station media access control layer is informed by the responding station physical layer to perform the packet receiving; and
subtract the second transmission time length from the second time spot and add the second processing time length thereon subsequently by using the responding station media access control layer to calculate the responding station initial data processing time.

3. The wireless communication system of claim 2, wherein the responding station apparatus and the initializing station apparatus perform the packet transmission and the packet receiving according to IEEE 802.11mc protocol.

4. The wireless communication system of claim 2, wherein the initializing station apparatus and the responding station apparatus are configured to perform the packet transmission and the packet receiving in a first communication behavior of a ranging communication, and the responding station apparatus transmits the information of the responding station initial data processing time to the initializing station apparatus in a second communication behavior in the ranging communication after the first communication behavior;
the ranging communication in turn comprises transmitting a ranging request signal by the initializing station apparatus to be received by the responding station apparatus, transmitting a first acknowledgement signal by the responding station apparatus to be received by the initializing station apparatus, transmitting a ranging signal from the responding station apparatus to be received by the initializing station apparatus, and transmitting a second acknowledgement signal by the initializing station apparatus to be received by the responding station apparatus; and
the first communication behavior is configured to transmit the ranging request signal and the second communication behavior is configured to transmit the ranging signal.

5. The wireless communication system of claim 4, wherein the ranging communication is performed based on a fine timing measurement (FTM) protocol and the initializing station initial data processing time and the responding station initial data processing time are recorded based on a timing synchronization function (TSF).

6. The wireless communication system of claim 5, wherein the responding station apparatus transmits the information of the responding station initial data processing time to the initializing station apparatus by using a synchronization information entry in a packet transmitted in the second communication behavior.

7. The wireless communication system of claim 1, wherein the transmission behavior is conducted by transmitting the communication packet from the responding station apparatus to the initializing station apparatus;
the responding station apparatus is configured to:
record a first time spot, by using a responding station media access control layer of the responding station apparatus, that the responding station physical layer is informed by the responding station media access control layer to perform a packet transmission of the communication packet;
calculate a first transmission time length, by using the responding station media access control layer, from a timing that the responding station physical layer is informed to perform the packet transmission to a timing that the responding station physical layer actually begins to perform the packet transmission;
process the communication packet by using the responding station physical layer and calculate a first processing time length, by using the responding station media access control layer, that a processing of a content from a packet header initial spot to a data initial spot of the data field of the communication packet takes;
add the first transmission time length and the first processing time length to the first time spot by using the responding station media access control layer to calculate the responding station initial data processing time; and
the initializing station apparatus is configured to:
record a second time spot, by using an initializing station media access control layer of the initializing station apparatus, that the initializing station media access control layer is informed by the initializing station physical layer to perform a packet receiving of the communication packet;
process the communication packet by using the initializing station physical layer and calculate a second processing time length, by using the initializing station media access control layer, that the processing of the content from a packet header initial spot to a data initial spot of the data field of the communication packet takes;
calculate a second transmission time length, by using the initializing station media access control layer, from a timing that the initializing station physical layer begins to perform the packet receiving to a timing that the initializing station media access control layer is informed by the initializing station physical layer to perform the packet receiving; and
subtract the second transmission time length from the second time spot and add the second processing time length thereon subsequently by using the initializing station media access control layer to calculate the initializing station initial data processing time.

8. The wireless communication system of claim 7, wherein the responding station apparatus and the initializing station apparatus perform the packet transmission and the packet receiving according to IEEE 802.11az protocol.

9. The wireless communication system of claim 7, wherein the initializing station apparatus and the responding station apparatus are configured to perform the packet transmission and the packet receiving in a first communication behavior of a ranging communication, and the responding station apparatus transmits the information of the responding station initial data processing time to the initializing station apparatus in a second communication behavior in the ranging communication after the first communication behavior;
the ranging communication in turn comprises transmitting a ranging polling signal by the responding station apparatus to be received by the initializing station apparatus, transmitting a clear-to-send signal by the initializing station apparatus to be received by the responding station apparatus, transmitting a ranging sounding signal by the responding station apparatus to be received by the initializing station apparatus, transmitting a first null data packet signal by the initializing station apparatus to be received by the responding station apparatus, transmitting a ranging null data packet announcement signal by the responding station apparatus to be received by the initializing station apparatus, transmitting a second null data packet signal by the responding station apparatus to be received by the initializing station apparatus, and transmitting a location measurement report signal by the responding station apparatus to be received by the initializing station apparatus; and
the first communication behavior is configured to transmit the ranging polling signal and the second communication behavior is configured to transmit the ranging null data packet announcement signal.

10. A wireless communication method having timing synchronization mechanism used in a wireless communication system, comprising:
conducting a transmission behavior corresponding to a communication packet with an initializing station apparatus operating according to an initializing station built-in timing by a responding station apparatus operating according to a responding station built-in timing;
according to the transmission behavior, calculating an initializing station initial data processing time that an initializing station physical layer of the initializing station apparatus spends to process a data field of the communication packet by the initializing station apparatus;
calculating a responding station initial data processing time that a responding station physical layer of the responding station apparatus spends to process the data field of the communication packet by the responding station apparatus;
transmitting information of the responding station initial data processing time by the responses station apparatus to the initializing station apparatus; and
calibrating the initializing station built-in timing by the initializing station apparatus to be synchronous with the responses station built-in timing according to a time difference between the initializing station initial data processing time and the responding station initial data processing time.

11. The wireless communication method of claim 10, wherein the transmission behavior is conducted by transmitting the communication packet from the initializing station apparatus to the responding station apparatus, the wireless communication method further comprising:
performing, by the initializing station apparatus, steps of:
recording a first time spot, by using an initializing station media access control layer of the initializing station apparatus, that the initializing station physical layer is informed by the initializing station media access control layer to perform a packet transmission of the communication packet;
calculating a first transmission time length, by using the initializing station media access control layer, from a timing that the initializing station physical layer is informed to perform the packet transmission to a timing that the initializing station physical layer actually begins to perform the packet transmission;
processing the communication packet by using the initializing station physical layer and calculating a first processing time length, by using the initializing station media access control layer, that a processing of a content from a packet header initial spot to a data initial spot of the data field of the communication packet takes;
adding the first transmission time length and the first processing time length to the first time spot by using the initializing station media access control layer to calculate the initializing station initial data processing time; and
performing, by the responding station apparatus, steps of:
recording a second time spot, by using a responding station media access control layer of the responding station apparatus, that the responding station media access control layer is informed by the responding station physical layer to perform a packet receiving of the communication packet;
processing the communication packet by using the responding station physical layer and calculate a second processing time length, by using the responding station media access control layer, that the processing of the content from a packet header initial spot to a data initial spot of the data field of the communication packet takes;
calculating a second transmission time length, by using the responding station media access control layer, from a timing that the responding station physical layer begins to perform the packet receiving to a timing that the responding station media access control layer is informed by the responding station physical layer to perform the packet receiving; and
subtracting the second transmission time length from the second time spot and add the second processing time length thereon subsequently by using the responding station media access control layer to calculate the responding station initial data processing time.

12. The wireless communication method of claim 11, wherein the responding station apparatus and the initializing station apparatus perform the packet transmission and the packet receiving according to IEEE 802.11mc protocol.

13. The wireless communication method of claim 11, further comprising:
performing the packet transmission and the packet receiving by the initializing station apparatus and the responding station apparatus in a first communication behavior of a ranging communication, and transmitting the information of the responding station initial data processing time by the responding station apparatus to the initializing station apparatus in a second communication behavior in the ranging communication after the first communication behavior;
wherein the ranging communication in turn comprises transmitting a ranging request signal by the initializing station apparatus to be received by the responding station apparatus, transmitting a first acknowledgement signal by the responding station apparatus to be received by the initializing station apparatus, transmitting a ranging signal from the responding station apparatus to be received by the initializing station apparatus, and transmitting a second acknowledgement signal by the initializing station apparatus to be received by the responding station apparatus; and
the first communication behavior is configured to transmit the ranging request signal and the second communication behavior is configured to transmit the ranging signal.

14. The wireless communication method of claim 13, further comprising:
performing the ranging communication based on a fine timing measurement protocol and recording the initializing station initial data processing time and the responding station initial data processing time based on a timing synchronization function.

15. The wireless communication method of claim 14, further comprising:
transmitting the information of the responding station initial data processing time by the responding station apparatus to the initializing station apparatus by using a synchronization information entry in a packet transmitted in the second communication behavior.

16. The wireless communication method of claim 10, wherein the transmission behavior is conducted by transmitting the communication packet from the responding station apparatus to the initializing station apparatus, the wireless communication method further comprising:
performing, by the responding station apparatus, steps of:
recording a first time spot, by using a responding station media access control layer of the responding station apparatus, that the responding station physical layer is informed by the responding station media access control layer to perform a packet transmission of the communication packet;
calculating a first transmission time length, by using the responding station media access control layer, from a timing that the responding station physical layer is informed to perform the packet transmission to a timing that the responding station physical layer actually begins to perform the packet transmission;
processing the communication packet by using the responding station physical layer and calculating a first processing time length, by using the responding station media access control layer, that a processing of a content from a packet header initial spot to a data initial spot of the data field of the communication packet takes;
adding the first transmission time length and the first processing time length to the first time spot by using the responding station media access control layer to calculate the responding station initial data processing time; and
performing, by the initializing station apparatus, steps of:
recording a second time spot, by using an initializing station media access control layer of the initializing station apparatus, that the initializing station media access control layer is informed by the initializing station physical layer to perform a packet receiving of the communication packet;
processing the communication packet by using the initializing station physical layer and calculate a second processing time length, by using the initializing station media access control layer, that the processing of the content from a packet header initial spot to a data initial spot of the data field of the communication packet takes;
calculating a second transmission time length, by using the initializing station media access control layer, from a timing that the initializing station physical layer begins to perform the packet receiving to a timing that the initializing station media access control layer is informed by the initializing station physical layer to perform the packet receiving; and
subtracting the second transmission time length from the second time spot and add the second processing time length thereon subsequently by using the initializing station media access control layer to calculate the initializing station initial data processing time.

17. The wireless communication method of claim 16, wherein the responding station apparatus and the initializing station apparatus perform the packet transmission and the packet receiving according to IEEE 802.11az protocol.

18. The wireless communication method of claim 16, further comprising:
performing the packet transmission and the packet receiving by the initializing station apparatus and the responding station apparatus in a first communication behavior of a ranging communication, and transmitting the information of the responding station initial data processing time by the responding station apparatus to the initializing station apparatus in a second communication behavior in the ranging communication after the first communication behavior;
wherein the ranging communication in turn comprises transmitting a ranging polling signal by the responding station apparatus to be received by the initializing station apparatus, transmitting a clear-to-send signal by the initializing station apparatus to be received by the responding station apparatus, transmitting a ranging sounding signal by the responding station apparatus to be received by the initializing station apparatus, transmitting a first null data packet signal by the initializing station apparatus to be received by the responding station apparatus, transmitting a ranging null data packet announcement signal by the responding station apparatus to be received by the initializing station apparatus, transmitting a second null data packet signal by the responding station apparatus to be received by the initializing station apparatus, and transmitting a location measurement report signal by the responding station apparatus to be received by the initializing station apparatus; and
the first communication behavior is configured to transmit the ranging polling signal and the second communication behavior is configured to transmit the ranging null data packet announcement signal.
